(19) United States
(12) Patent Application Publication
(10) Pub. No.: US 2009/0127083 A1
(43) Pub. Date: May 21, 2009

(54) SWITCHING SHAFT UNIT FOR AN ELECTRICAL CONTACT SYSTEM

(75) Inventor: Kurt Haendler, Bonn (DE)

Correspondence Address: DARBY & DARBY P.C., P.O. BOX 770, Church Street Station, New York, NY, 10008-0770, US

(73) Assignee: Moeller GmbH, Bonn (DE)

(21) Appl. No.: 12/281,107

(22) PCT Filed: Mar. 1, 2007
(86) PCT No.: PCT/EP07/01748

§ 371 Date: Aug. 28, 2008

(30) Foreign Application Priority Data
Mar. 2, 2006 (DE) 102006009645.2

(51) Int. Cl. H01H 1/00

(52) U.S. Cl. 200/290

(57) ABSTRACT

A switching shaft unit for an electrical contact system for use in a low-voltage breaker. The switching shaft unit includes a rotary contact moveably disposed, with play, in a switching shaft or a shifting shaft segment, and having a pair of bearing pins. The switching shaft unit further includes at least one contact piece configured to make switchable contact with at least one fixed contact, and at least one pair of force springs. Each force spring is supported by an associated respective support disposed in an interior of the switching shaft or the switching shaft segment, and an associated respective bearing pin, so that, upon an opening movement of the rotary contact, a connection line defined through the associated bearing pin and the associated support of at least one of the force springs is displaced over a breakover point plane so that the rotary contact remains in an open position.

### CROSS REFERENCE TO PRIOR APPLICATIONS

This application is a U.S. National Phase application under 35 U.S.C. §371 of International Application No. PCT/EP2007/001748, filed on Mar. 1, 2007, and claims benefit to German Patent Application No. 10 2006 009 645.2, filed on Mar. 2, 2006. The International Application was published in German on Sep. 7, 2007 as WO 2007/098943

### FIELD

The present invention relates to a switching shaft unit for an electrical, tilting contact system for use in an at least single-pole circuit breaker having an insulating material housing.

### BACKGROUND

Spring elements are generally used in electrical contact systems to increase the contact force. Helical springs, which act on the contact lever in the direction towards the closed position of the contact system, by means of traction or by means of pressure according to the construction, may be used as spring elements. The contact-force-increasing means are used with single-armed and double-armed contact levers. Using symmetrically-arranged contact force springs further allows the contact system to be mounted with play. In the case of double-armed contact levers, it is possible for a balance between the contact forces to be established when the contact pieces are worn to different degrees. An approximate balance in the contact forces can be retained despite the asymmetry in the heights of the contact pieces and the related change in position of the axis of rotation and the change in length of the lever arms of the contact force springs acting thereon. The development of this type of contact system led to what are known as tilting contact systems, which assume a stable position for closing the contacts and a stable position for opening the contacts. In this case, the spring element forces are guided over an unstable breakover point plane in such a way that, after being spun with an opening force sufficient to exceed the unstable breakover point position, the contact system remains in the open position.

In order to form contact systems as tilting contact systems, irrespective of whether a single-armed or double-armed system is involved, the contact system generally includes a breakover point position so that the contact lever or contact arm can pivot over this breakover point position.

EP 889 498 A2 describes a double-armed contact system having a switching shaft which is disposed in a slot and in which a contact force tension spring is arranged on each of the two sides of the contact arm. The tension springs are suspended at both ends in spring pins which are guided in recesses extending parallel to the slot by switching shaft portions and which act on opposite contact surface of the lever arms.

Switching shaft units are generally constructed with tight space restrictions and thus relatively small spring elements are preferably used in each case. This results in a relatively small effective pivot point distance and the resulting contact forces are therefore very likely to be affected by tolerances. This leads to a high degree of variation in the actual contact forces. After erosion of the contacts, the lever ratios are altered and the contact forces are thus also altered to an equivalent extent. In order to generate high closing forces, it is preferable to apply high spring forces. Since switching shafts are generally made of plastics material, there is a risk of deformation of the switching shaft or the bearing points thereof, will receive the forces under high thermal load. Reinforcing the material is difficult since the space requirements and the material dimensions are already optimally designed. The bearing points are therefore subject to a relatively high degree of wear.

An example in which spring elements operate using pressure in the compact space of the switching shaft is shown in DE 103 58 828 A1. This switching shaft unit is composed of a relatively large number of components. The means for mounting the pressure spring on the rotary contact in particular includes a complicated component which is subject to a high degree of stress (rocker). Due to the space restrictions, it is preferable to construct the spring elements in such a way that the material loading capacity thereof is pushed to the limit. Moreover, the material thickness of the support points for the spring elements in the switching shaft is relatively thin in order to allow enough room for the stroke of the springs. The thinness of the material at the edge of the switching shaft is a further weak point of this construction.

A drawback of embodiments of this type is that, when a relatively large number of components are used, each component contributes to wear and tolerances are introduced due to the large number of parts. Metal products and plastics material moulded parts are preferably formed so as to match one another are used as components. Component production tolerances form a tolerance chain which has a negative effect on the strength and uniformity of the contact forces and on the position of the contact pieces (overlapping) and thus causes erosion and wear.

If relatively small contact force springs are intended to generate high spring forces with relatively small effective lever arms, optimum quality spring materials are preferably used, but these lie on the threshold of manufacturability.

### SUMMARY

An aspect of the present invention is to provide a switching shaft unit for a tilting contact system, without increasing the geometric dimensions thereof, while reducing the number of components.

In an embodiment, the present invention provides a switching shaft unit for an electrical contact system for use in an at least single-pole low-voltage breaker having an insulating material housing. The switching shaft unit includes an at least single-interrupting rotary contact having a form of a lever and being moveably disposed, with play, in a switching shaft or a shifting shaft segment, the rotary contact having a pair of bearing pins. The switching shaft unit further includes at least one contact piece disposed on the rotary contact and configured to make switchable contact with at least one fixed contact, and at least one pair of force springs configured to bend about a central axis and act on the rotary contact. Each force spring has a first end and a second end, the first end being supported by an associated respective support disposed in an interior of the switching shaft or the switching shaft segment, and the second end being supported by an associated respective bearing pin of the bearing pins, so that, upon an opening movement of the rotary contact, a connection line defined through the associated bearing pin and the associated support of at least one of the force springs is displaced over a breakover point plane so that the rotary contact remains in an open position.

### BRIEF DESCRIPTION OF THE DRAWINGS

Further details and advantages of the invention will emerge from the following embodiments, described in relation to the figures, in which:

FIG. 1 shows a schematic view of a double-interrupting contact system according to an aspect of the present invention;

FIG. 2 shows an embodiment of the present invention having S-shaped leaf springs in the closed position of the contacts;

FIG. 3 shows an embodiment according to the present invention having V-shaped leaf springs;

FIG. 4 shows an embodiment according to the present invention having S-shaped leaf springs in the open position of the contacts; and

FIG. 5 shows an embodiment according to the present invention having double leaf springs in the closed position of the contacts.

### DETAILED DESCRIPTION

An aspect according to the present invention involves forming the contact force springs as springs which are subject to a bending stress about the central axis thereof. Leaf springs are preferably used. The arrangement is intended to be loaded for a single-interrupting or a double-interrupting rotary contact. In this respect, the rotary contact can be formed as a single-armed or double-armed lever.

The contact force springs are preferably arranged on either side of the rotary contact so as to be symmetrical in pairs. The rotary contact can be moved in a manner delimited by a slot, without being obstructed by the springs, from one end position into the other end position, and is thus guided in a rotary manner by the contact force springs in the process. In this way, a wider pivot range of the force vector resulting from the spring position is achieved by using large effective lever arms in the contact ON position and in the contact spun position.

The device allows optimal lever ratios to be achieved. In an embodiment according to the present invention, the material loads (maximum edge stress) of the contact force springs are kept within controllable limits. Smaller forces are generated and the production tolerances have less of an influence on the quality of the finished product. The specific lever ratios will be discussed in detail in the description of the figures.

At least three different versions of curved leaf springs are proposed. The leaf springs are subject to a bending stress about the central axis thereof, the leaf springs not being arranged in a flat, straight manner, but being curved at least once.

In the first version, the leaf springs are formed with a single curve. The shape may be referred to as a U-shape or a V-shape, in which the tips of the V form the ends of the leaf springs which are each supported at that location. The highest degree of material stress (edge stress) occurs at the peak of the curve.

In the second version, each leaf spring includes two curves, forming an S-shaped curve, in which the ends of the S are the ends of the leaf springs and are each supported at that location. The curves thus extend beyond both sides of the imaginary lines between the support points.

The flat side of each leaf spring is positioned perpendicular to the plane through which the rotary contact passes during a switching procedure.

The position of the support points of the leaf springs depends on the selected leaf spring shape. For an S-shape, the support points are generally positioned relatively symmetrically in relation to the free space in the switching shaft, whereas the V-shape only has one curve, and therefore the support points are shifted out from a central position and the curve is then located only on one side of the connecting line between the support points.

The respective ends of the leaf springs are curved into a circle which matches the diameters of the bearing pins in such a way that they fit closely around said pins.

Forming the leaf springs as double leaf springs is a preferred variant of both aforementioned versions. A double leaf may be used for both the V-shaped springs and the S-shaped springs. The V-shaped double leaf spring is shown and discussed in greater detail in the description of the figures.

The curves of the leaf spring preferably do not exceed the space available inside the switching shaft and the curves are thus located within these predetermined boundaries. However, slightly exceeding this amount of space allows the material requirements to be reduced. Leaf springs which are formed so as to be larger and longer, when a greater amount of space is available, are subject to a lower degree of edge stress.

In an exemplary embodiment according to the present invention, the distance between the support points (ends of the leaf springs) is between approximately 7 and 8 mm. During movement into the open position, the distance grows shorter by approximately 3 to 4 mm and the leaf springs are accordingly subjected to a bending stress. The springs can accommodate forces of approximately 50 N. Since the spring force is a result of the spring excursion and the spring constant, lower values for the material quality (spring constant) may be selected in the case of a relatively large spring excursion. On examination of these dimensions, it is also clear that the final tolerance (from the production chain and possible play of the components) of 0.3 mm for a spring excursion of 3 mm is approximately 10%. Keeping tolerances below a value of several 100 μm with a large number of components is extremely complex.

The contact force springs are subject to increased bending during the course of movement out of the basic position through the breakover point plane. The greatest material stress occurs in the edge regions of the curve. It has been found that the maximum edge stress in leaf springs is approximately 1,800 N/mm², whereas, when using helical springs which operate using pressure, the maximum material stress is approximately 5% greater. Furthermore, tests have shown that, when using the further “double leaf spring” embodiment, the greatest edge stress is approximately 5% lower than the aforementioned value of 1,800 N/mm². The spring leaf strips of the double leaf springs are formed so as to be thinner, but both absorb the forces. Therefore the edge stress in each double sheet does not reach the maximum value attained by a single spring.

Due to the different use of space by the proposed spring variants, a S-shaped spring leaf may be longer (i.e. the bendable length thereof) than a V-shaped leaf spring. A V-shaped spring leaf is preferably formed so as to be thicker than a S-shaped leaf spring in order to exert the same material stress.

Preferably provided on the rotary contact is at least one guide contour which cooperates with a guide edge on the switching shaft portion during the rotational movement of the rotary contact. The edge and the contour are positioned with play in such a way that, in the vicinity of the breakover point plane, the rotary contact can deviate slightly, and this would lead to it “breaking out” of the breakover point position in certain cases. A further advantage of the edge and the contour being positioned with play is that there is as little friction as possible.

The feature of mounting the rotary contact in a slot in the switching shaft portion with play so as to be rotatable about a guide axis is adopted for the same reasons.

The present invention is preferably to be used in circuit breakers or motor circuit breakers.

The contact system configured for a pole of a multipolar circuit breaker is transferred in the conventional manner from the off position to the on position and vice-versa by an actuation mechanism (not shown). In the case of a short-circuit current, repulsive electrodynamic forces occur, which spin the rotary contact from the on position into a repulsed position. In order to ensure that the rotary contact does not automatically fall from the repulsed position or open position back into the on position, the contact system is equipped with a tilting snap-action mechanism which is formed so as to be rotationally symmetrical about to the bearing axis.

An embodiment according to the present invention including a single-armed rotary contact is not shown in the drawings.

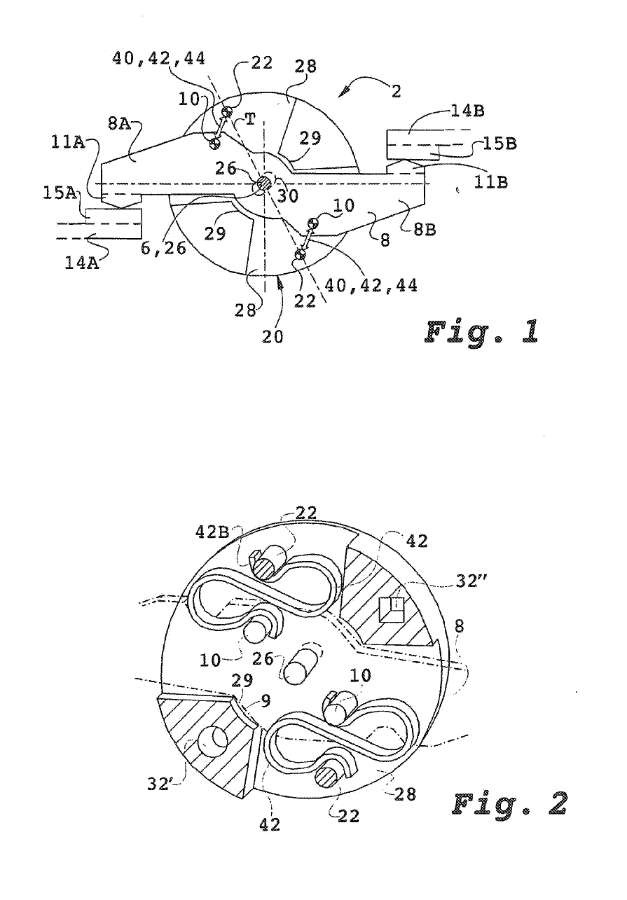

FIG. 1 is a schematic view of the tilting snap-action mechanism, which is assembled from the double-armed rotary contact 8, the switching shaft portion 20 and the two pairs of contact pressure springs 40, 42, 44. The contact pressure between the contact piece pairs is produced by the contact force springs 40, 42, 44, formed as leaf springs (preferably made of spring steel). At the breakover point of the tilting snap-action mechanism, the force vectors of the springs extend through the axis of rotation 26 of the rotary contact, thus forming the breakover point plane T.

It is generally known in the art that there are two options for mounting the rotary contact in the switching shaft. Either the rotary contact can be mounted via a physical spindle in a hole in the switching shaft or a hole is provided in the rotary contact and the rotary contact moves about a guide shaft formed in the switching shaft. Either of these constructional options may be used for the embodiments according to the present invention.

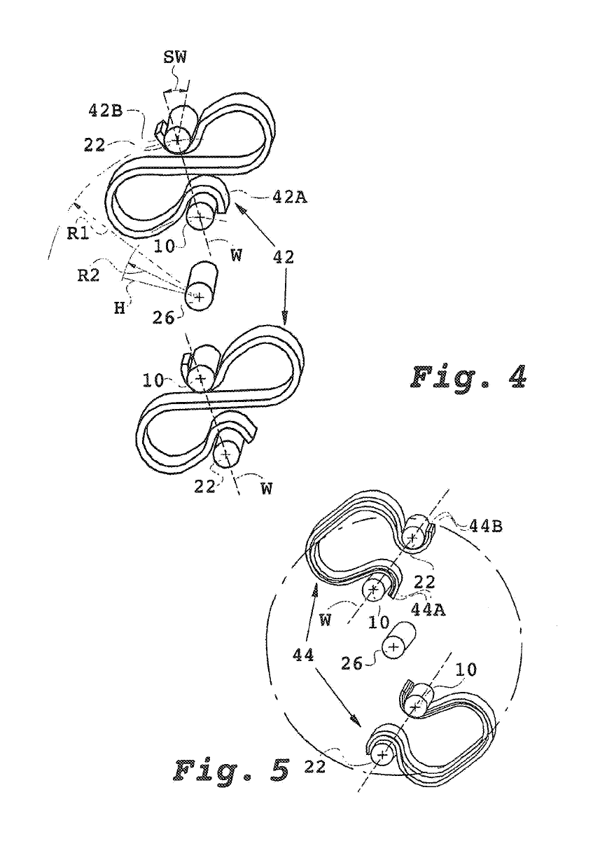

The rotationally symmetrical rotary contact 8 includes two lever arms 8A and 8B, the ends of which are each provided with a movable contact piece 11A, 11B. When the contact system is closed, the contact pieces 11A, 11B are each electrically connected to a fixed contact piece 15A or 15B on a connecting bar 14A or 14B. One of a pair of leaf springs 40, 42, 44 is mounted in each of the upper and lower regions of the rotary contact between a bearing pin 10 on the rotary contact and a support in the switching shaft. The support 22 for the leaf spring is composed of a shaft 22 formed between the inner walls of the switching shaft 20. One end 40A (42A, 44A) of the leaf springs acts on the switching shaft portion 22 and the other end 40B (42B, 44B) acts on one of the lever arms (8A or 8B). The contact force springs produce pressure in the direction of action W (see FIG. 3 or 4). The direction of action extends in each case over the ends 40A and 40B. Two contact force springs are arranged on either side of the rotary contact 8 in such a way that the rotary contact can move in an unobstructed manner. The figures are to be viewed as longitudinal sections and therefore only one pair of contact force springs is visible.

The first ends 40A (42A, 44A) and the second ends 40B (42B, 44B) of the contact force springs are positioned so as to be diametrically opposed in relation to the axis 26 (in the switching shaft). If, in the case of a short circuit, the rotary contact is spun, the contact force springs and, together therewith, the resulting forces pivot over the breakover point plane T in such a way that a locking torque acts on the rotary contact. The connection line between the bearing pin 10 and the support 22 shifts over the breakover point plane T and the rotary contact 8 remains in the open position. FIG. 4 shows the open position.

Provided on the rotary contact 8 is at least one circular guide contour 9 which cooperates with the circular guide edge 29 on the switching shaft portion during the rotational movement of the rotary contact. In accordance with the figures, two guide contours 9 and two complementary guide edges are provided in this case. The edge and the contour are positioned with play.

The play involved when mounting the rotary contact in the switching shaft may be approximately 100 μm. The play of the guide shaft is preferably smaller than the play tolerance between the edge and the contour.

The rotary contact is formed with a slot 30, the longitudinal extension of which should extend as far as possible in the direction in which it is allowed to move with play. The rotary contact is guided to the greatest extent perpendicular to the longitudinal extension, which means, for example, that it is not possible for the contacts to deviate from the superposed contact position in the closed position. In general, however, a compromise is made regarding the position of the longitudinal direction of the slot, which is intended to be indicated as an oblique position in FIG. 1.

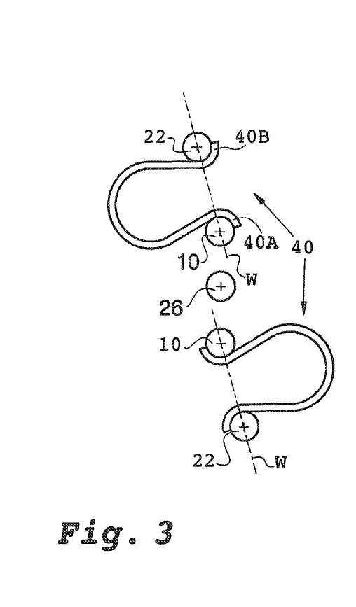

FIG. 2 is a cross-section through the switching shaft portion 20 and shows the position of the contact force springs 42 with two curves in an S-shaped curved position and the supports (shafts 22) of said springs. The curves of the leaf springs 42 lie within the boundary 28 of the space in the switching shaft 20. In contrast, FIG. 5 provides an illustration in which the contact force springs (44) project beyond the boundary. The contacts are in the closed position. The rotary contact 8 is indicated in broken lines. Two holes 32′, 32″ in the switching shaft are provided for engaging entrainment elements to a drive spindle. In a proven configuration, the leaf springs are 5 mm wide and between 0.4 and 0.5 mm thick, the rotary contact being 4 mm thick. The clearance in the switching shaft is approximately 10 mm wide in this case.

FIG. 3 shows an embodiment according to the present invention having V-shaped leaf springs 40 and the support sites (22) or contact sites (10) of the leaf springs, without showing the switching shaft and the rotary contact in the open position of the contacts in greater detail. All further details have been omitted, but the bearing axis 26 and the lines of action W can still be seen.

FIG. 4 shows an embodiment according to the present invention having S-shaped leaf springs 42 in a manner comparable to FIG. 3 (contacts in the open position). In order to describe the lever ratios of the contact force springs, FIG. 4 also shows the radii R1 and R2. The contact point 10 moves in a circle having the radius R2 with the schematically indicated pivot angle SW. The torque that can be generated by the leaf spring 42 is determined by the leaf strength and the lever arm H. It is clear from the diagram that the maximum spring stress is inversely proportional to the lever arm. The longer the lever arm, the smaller the spring stress can be. Weaker springs may be utilised if longer lever arms are used. This means that, in terms of material load, it is favourable to configure, as far as possible, the use of space in such a way that large lever arms are provided. It is to be understood that the force ratios depend on the position of the support sites 22 and contact sites 10, and this of course means, in terms of the different embodiments, that the force ratios are dependent on the selected leaf spring shape. In this respect, a V-shaped leaf spring has more favourable stress ratios, since it is supported deep in the switching shaft and the contact site 10 has a relatively long path along the circle with the radius R2.

FIG. 5 shows an embodiment according to the present invention having double leaf springs 44 in the closed position of the contacts. Both pairs of double leaf spring 44 are shown in a perspective view. Two pairs of contact force springs (40, 42, 44) having the same configuration are used for each embodiment. The line W of action extends upwards to the left and downwards to the right at a relatively large distance (H) past the axis of rotation 26. The outline of the switching shaft portion is shown schematically in broken lines to indicate that the curves of the leaf springs 44 are located beyond the boundary 28 of the space in the switching shaft 20 in this embodiment. In this way greater length of the leaf springs is obtained, which allows the maximum edge stress of the leaf springs to be reduced.

The present invention is not limited to the embodiments described above in the figures, but rather includes all of the embodiments which operate in the same way in the meaning of the invention. The invention may thus be used for a single-interrupting rotary contact or a double-interrupting rotary contact. The configuration of the lever arm, the way in which it is mounted in the switching shaft and the position of the bearing points for the lever arm and the leaf springs is to be varied accordingly. Further, reference should be had to the appended claims.

### LIST OF REFERENCE NUMERALS

2 contact system
8 rotary contact
8A, 8B lever arms
9 guide contour
10 bearing pin, contact site
11A, 11B contact piece (movable)
14A, 14B busbars
15A, 15B fixed contact pieces
20 switching shaft
22 shaft, support
26 axis of rotation
28 clearance in switching shaft
29 guide edge in switching shaft
30 slot
32′, 32″ hole for entrainment means on a drive spindle
40 contact force spring (V-shape)
40A, 42A, 44A first spring end
40B, 42B, 44B second spring end
42 contact force spring (S-shape)
44 contact force spring as a double leaf
R1, R2 radii
SW pivot angle
W line of action

1-11. (canceled)

12. A switching shaft unit for an electrical contact system for use in an at least single-pole low-voltage breaker having an insulating material housing, comprising:
an at least single-interrupting rotary contact having a form of a lever and being moveably disposed, with play, in a switching shaft or a shifting shaft segment, the rotary contact having a pair of bearing pins;
at least one contact piece disposed on the rotary contact and configured to make switchable contact with at least one fixed contact; and
at least one pair of force springs configured to bend about a central axis and act on the rotary contact, each force spring having a first end and a second end, the first end being supported by an associated respective support disposed in an interior of the switching shaft or the switching shaft segment, and the second end being supported by an associated respective bearing pin of the bearing pins, so that, upon an opening movement of the rotary contact, a connection line defined through the associated bearing pin and the associated support of at least one of the force springs is displaced over a breakover point plane so that the rotary contact remains in an open position.

13. The switching shaft unit as recited in claim 12, wherein the rotary contact is a double-interrupting rotary contact and the lever is a double-armed lever having a first lever arm and a second lever arm, each lever arm having a respective contact piece of the at least one contact piece disposed thereon and configured to make switchable contact with a respective fixed contact of the at least one fixed contact.

14. The switching shaft unit as recited in claim 12, wherein each contact spring of the pair of contact force springs is symmetrically disposed on a respective side of the rotary contact.

15. The switching shaft unit as recited in claim 12, wherein the pair of contact force springs are leaf springs having a flat side disposed perpendicular to a plane through which the rotary contact passes during a switching procedure.

16. The switching shaft unit as recited in claim 15, wherein each leaf springs includes a curve.

17. The switching shaft unit as recited in claim 15, wherein each leaf spring includes two curves, forming an S-shape.

18. The switching shaft unit as recited in claim 15, wherein the leaf spring are double leaf blades.

19. The switching shaft unit as recited in claim 16, wherein the respective curve of each of the leaf springs is disposed within a boundary of the switching shaft or the switching shaft segment.

20. The switching shaft unit as recited in claim 12, wherein each of the supports is a shaft formed between a first inner wall and a second inner wall of the switching shaft or the switching shaft segment.

21. The switching shaft unit as recited in claim 12, wherein the rotary contact includes at least one guide contour configured to cooperate with a guide edge of the switching shaft or the switching shaft segment during a rotational movement of the rotary contact.

22. The switching shaft unit as recited in claim 12, wherein the rotary contact is disposed in the switching shaft or the switching shaft segment so as to be rotatable about a guide axis delimited by a slot.
